(19) United States
(12) Patent Application Publication
(10) Pub. No.: US 2010/0147915 A1
(43) Pub. Date: Jun. 17, 2010

(54) Snowmobile Accessories

(76) Inventors: Chris Roberts, Clarkston, WA (US); Kathy Roberts, Clarkston, WA (US)

Correspondence Address: WELLS ST. JOHN P.S., 601 W. FIRST AVENUE, SUITE 1300, SPOKANE, WA, 99201, US

(21) Appl. No.: 12/333,141

(22) Filed: Dec. 11, 2008

(51) Int. Cl. B60R 9/00

(52) U.S. Cl. 224/408

(57) ABSTRACT

Removable storage compartments are provided that can include a compartment housing formed to extend along sidewalls from a base portion and define an opening, a lid configured to couple with the housing and at least partially close the opening, with the lid not extending beyond the outermost portion of the sidewalls. Compartments can also have a least one mounting bracket recessed within at least one of the sidewalls. Methods of mounting a storage compartment to a snowmobile are provided that can include mounting a portion of a hasp to a portion of a snowmobile, providing a storage compartment having another portion of the hasp mounted thereto, and coupling the portions of the hasp to mount the compartment to the snowmobile, the coupled compartment having the hasp recessed below the compartment and within a perimeter define by the compartment. Ornamental designs for snowmobile accessories as shown in FIGS. 6-12.

### TECHNICAL FIELD

The present disclosure relates to personal transport accessories and in particular embodiments to snowmobile accessories.

### BACKGROUND

Personal transport vehicles such as snowmobiles typically are designed to transport a single person and little attention is given to storage space for personal or even safety items. Snowmobiles, for example are typically designed to provide comfort to the rider and at the same time maximize transport efficiency. As part of maximizing efficiency, storage of personal and/or safety items, for example, are typically not accounted for and riders are left to transport items using backpacks. Backpacks can be unsafe as they may cause the rider to be unbalanced when riding and/or provide an item that can become snagged on low hanging branches, for example.

### SUMMARY OF DISCLOSURE

Removable storage compartments configured to mount rear of a snowmobile seat are provided. The compartments can include a compartment housing formed to extend along sidewalls from a base portion and define an opening, the sidewalls defining the outermost portion of the compartment in one cross section. The compartments can also include a lid configured to couple with the housing and at least partially close the opening, wherein the lid does not extend beyond the outermost portion of the sidewalls when coupled with the housing in one cross section.

Compartments can also be configured to include a compartment housing formed to extend vertically along sidewalls from a base portion and define an opening above the base portion, the sidewalls defining the outermost portion of the compartment in one cross section. The compartment can also have a lid configured to compliment the opening, and a least one mounting bracket recessed within at least one of the sidewalls.

Methods of mounting a storage compartment to a snowmobile are provided that can include mounting a portion of a hasp to a portion of a snowmobile, providing a storage compartment having another portion of the hasp mounted thereto, and coupling the portions of the hasp to mount the compartment to the snowmobile, the coupled compartment having the hasp recessed below the compartment and within a perimeter defined by the compartment.

Ornamental designs for snowmobile accessories as shown in FIGS. 6-12.

### DRAWINGS

Embodiments of the disclosure are described below with reference to the following accompanying drawings.

FIG. 1. is an isometric view of an accessory according to an embodiment of the disclosure.

FIGS. 2A, 2B, and 2C are lateral as well as cross sections and detail views of an accessory according to embodiments of the disclosure.

FIGS. 3A, 3B, 3C, and 3D are multiple views of an accessory according to embodiments of the disclosure.

FIGS. 4A, 4B, and 4C are multiple views of an accessory according to embodiments of the disclosure.

FIG. 5 is a snowmobile having a snowmobile accessory according to an embodiment of the present disclosure thereon.

FIG. 6 is a perspective view of a snowmobile accessory according to an embodiment.

FIG. 7 is a left side view of the snowmobile accessory of FIG. 7.

FIG. 8 is a right side view of the snowmobile accessory of FIG. 7.

FIG. 9 is a rear view of the snowmobile accessory of FIG. 7.

FIG. 10 is a front view of the snowmobile accessory of FIG. 7.

FIG. 11 is a top view of the snowmobile accessory of FIG. 7.

FIG. 12 is a bottom view of the snowmobile accessory of FIG. 7.

### DESCRIPTION

This disclosure is submitted in furtherance of the constitutional purposes of the U.S. Patent Laws “to promote the progress of science and useful arts” (Article 1, Section 8).

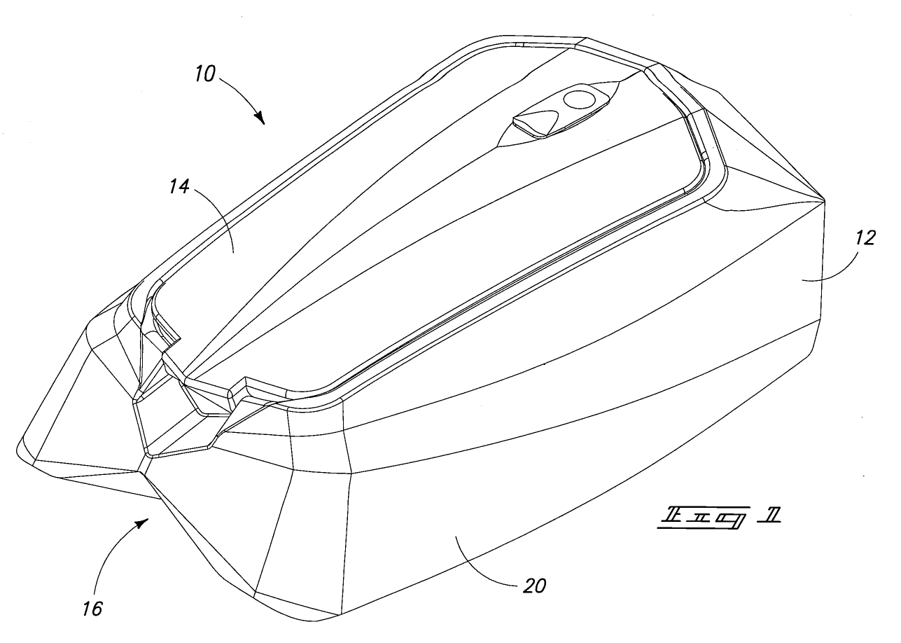

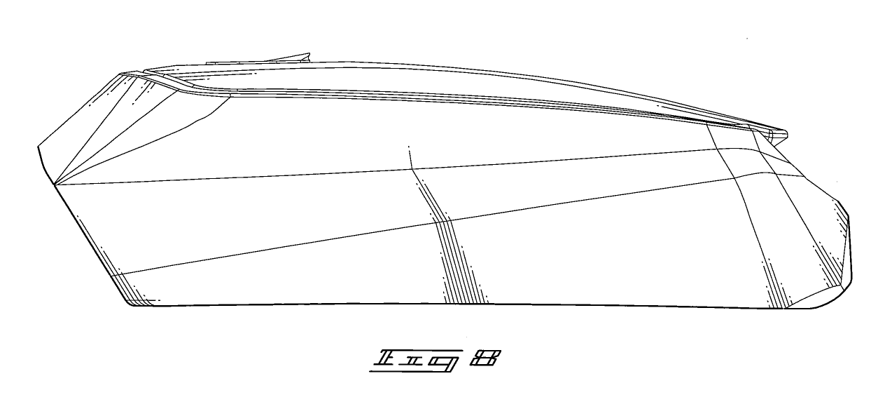

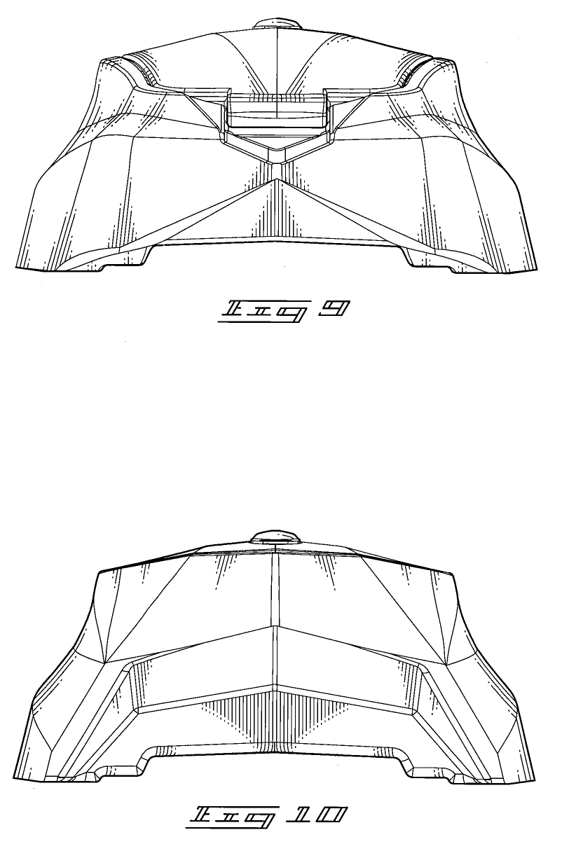

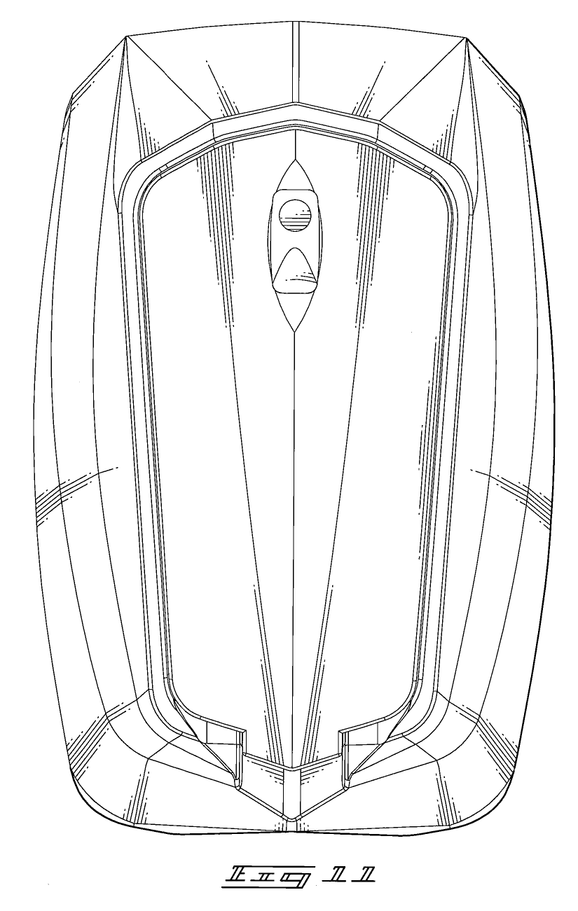

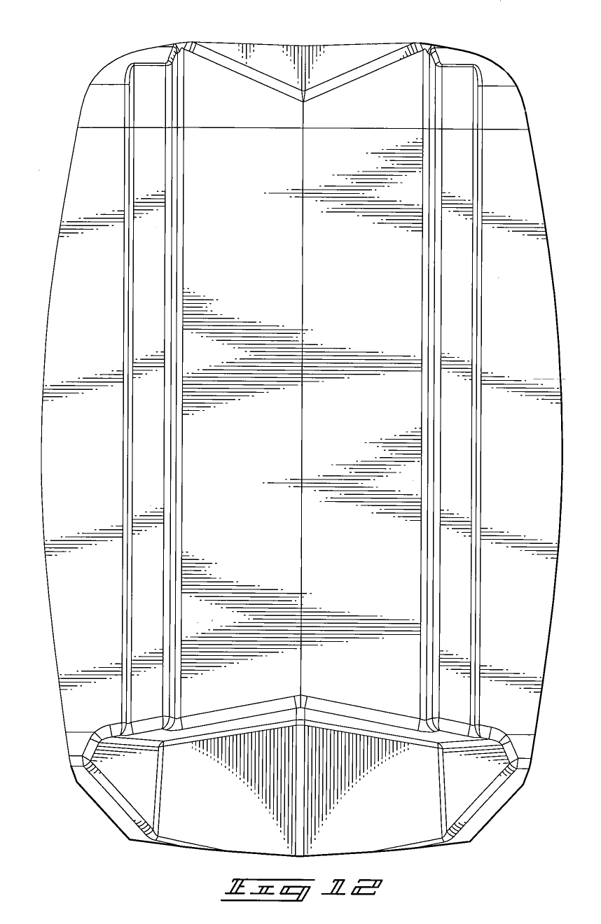

Snowmobile accessories of the present disclosure include removable snowmobile storage compartments and methods of using same. These accessories are described with reference to FIGS. 1-13. Referring to FIG. 1, an isometric view of removable compartment 10 is shown that includes housing 12 and lid 14. According to example implementations, the storage compartment can be configured to compliment and/or engage with the rear portion of a snowmobile seat. Housing 12 can include a recess 16 to facilitate the mounting to the rear of a snowmobile seat. Typically, snowmobiles include an extension extending over the snowmobile tracks to protect the rider in the event the rider falls from the snowmobile. According to example implementations, the accessory can be mounted above that extension. The housing and/or lid can comprise a rigid material such as a plastic, fiberglass, polycarbonate, carbon fiber, and/or metal materials, for example. Lid 14 may also comprise a flexible material, even a fabric type material, for example.

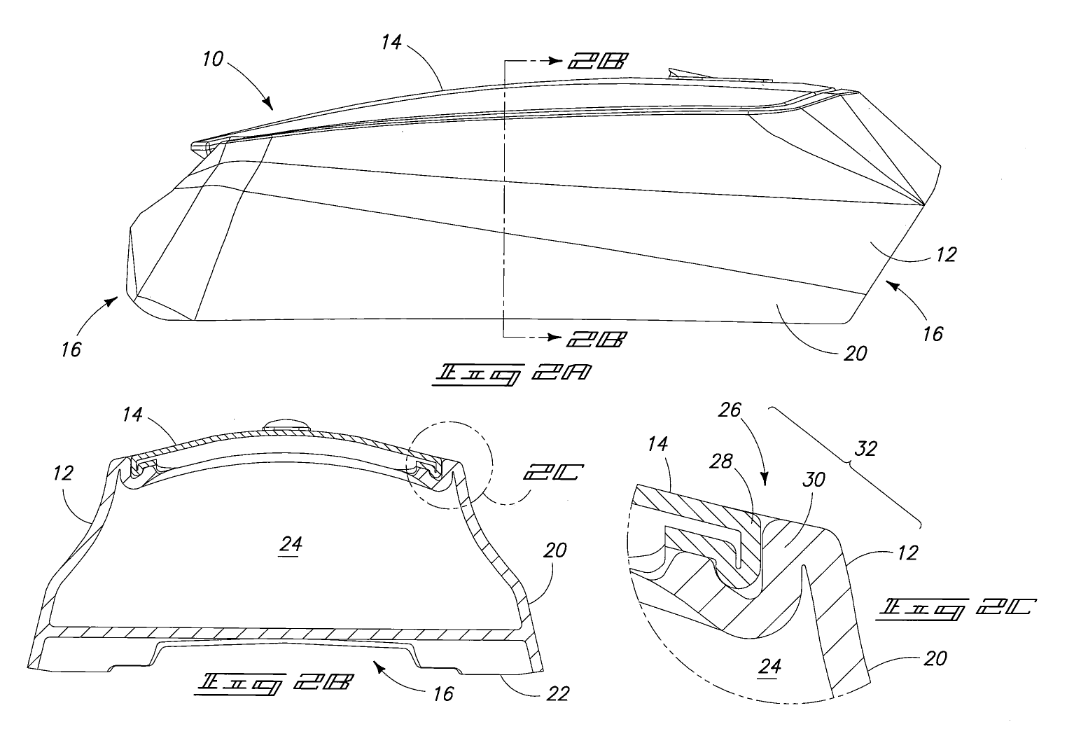

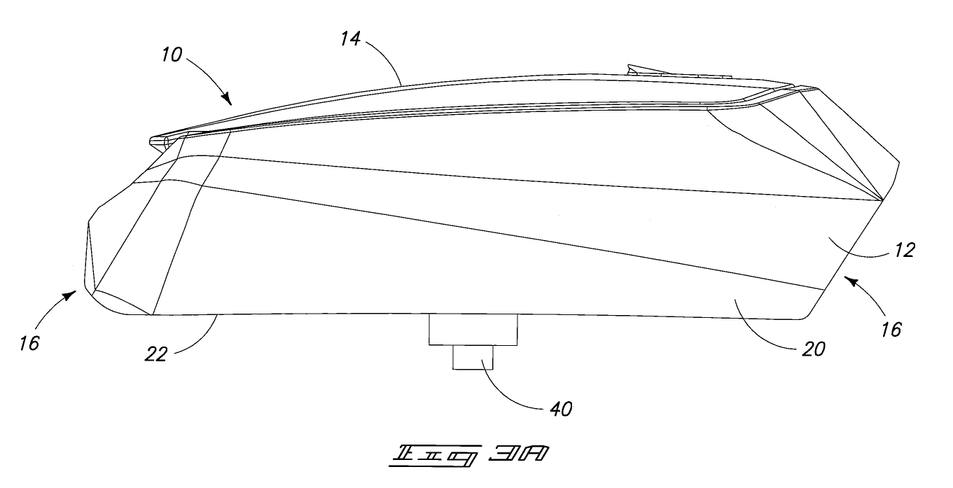

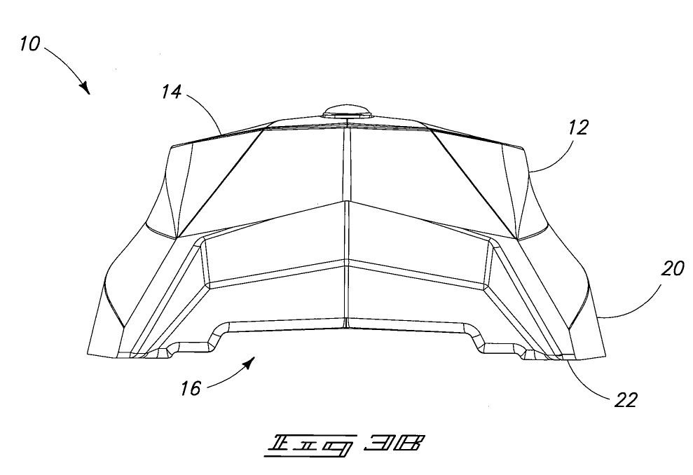

Referring to FIGS. 2A through 2C, compartment 10 can include compartment housing 12 that extends along sidewalls 20 from a base portion 22, with the sidewalls defining the outermost portion of the compartment in one cross section. Lid 14 can be configured to couple with the housing and at least partially, if not fully, close the opening defined by sidewalls 20 which extend from base 22. As can be seen in FIG. 2B, according to an example implementation, lid 14 can be configured to be received within sidewalls 20 of compartment 10 in one cross section. With reference to FIG. 2C, lid 14 and compartment 10, particularly sidewall 20 of compartment 10, can include complimentary portions as shown in portions 26 configured to provide a rigid coupling when the lid is coupled to the compartment. According to example implementations, the outer edge 28 of lid 14 can be configured to compliment inner edge 30 of sidewalls 20 to form an arcuate joint 32.

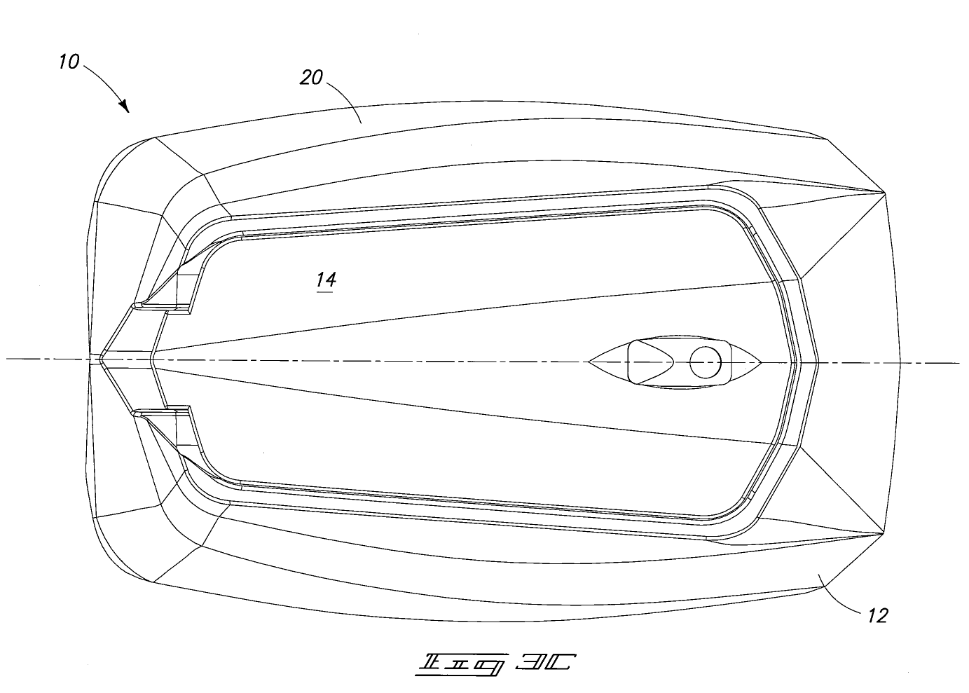

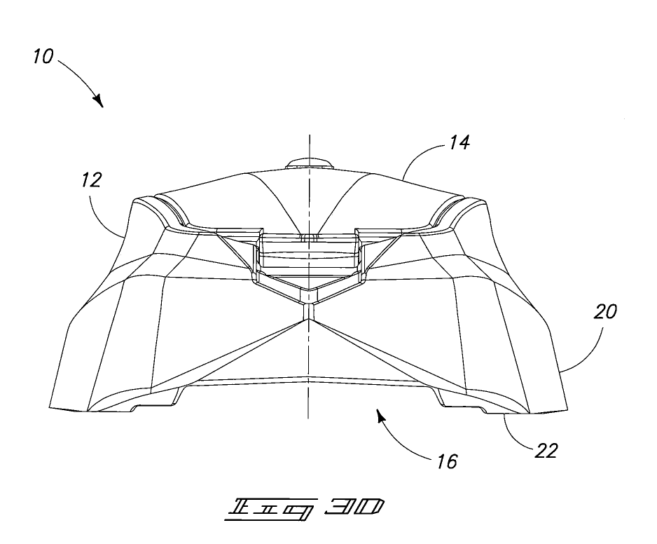

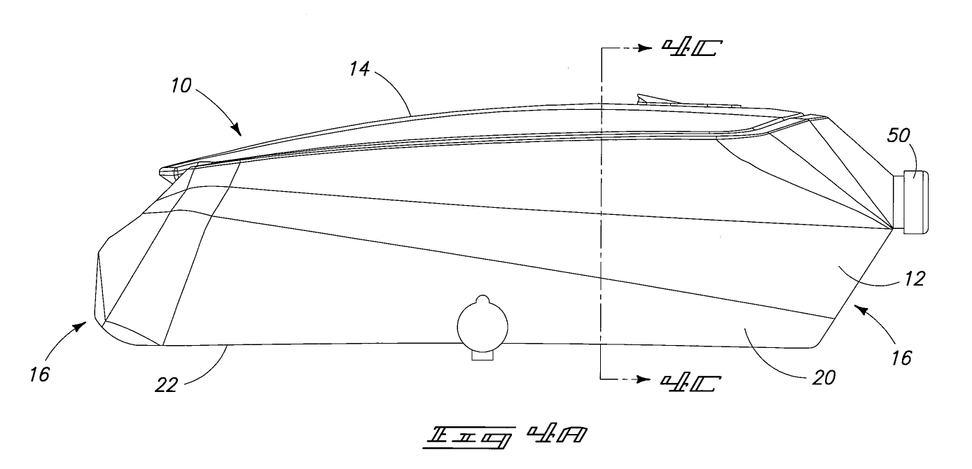

Referring to FIGS. 3A through 3D, compartment 10 can be configured to include at least one mounting bracket 40 recessed within at least one of the sidewalls 20. This mounting bracket can be a hasp, for example, and as such, the compartment can be configured to be removably-affixedly coupled to the snowmobile. By being removably-affixedly coupled, the compartment can be affixed to the snowmobile and then removed from the snowmobile via use of the hasp, for example. According to implementations, bracket 40 can be a quick release mechanism, allowing the snowmobile rider to release the compartment from the snowmobile while wearing weather protective gear such as snowmobile gloves. According to example implementations, the hasp can be a draw hasp, for example.

Compartment size can depend, for example, on the snowmobile to which they are to be attached. According to example implementations, the size of the compartment may not extend beyond a perimeter defined rearward of the seat of the snowmobile. As an example, implemented according to an embodiment, an affixed compartment can allow a snowmobile rider to easily exit and mount the snowmobile, for example, without being impeded by edges of the compartment. According to example implementations, housing 12 and lid 14 can define an interior of the compartment such as that shown in FIG. 2B.

According to example implementations, the interior of the compartment can be undivided. According to other implementations, the interior of the compartment can further define regions configured to receive additional accessories and/or tools, for example, flashlights and/or safety equipment such as flares. According to other implementations, a tail light may be directly mounted to the compartment and the compartment may be configured with an electrical adapter configured to couple to the snowmobile and provide power to the tail light. According to other implementations, the compartment may be rigidly affixed or permanently affixed to the snowmobile utilizing bolts, for example. According to other implementations, the compartment and snowmobile may include complimentary Velcro equipped pads or alignment pins and openings to be used to prevent side-to-side or end play movement between the compartment and the tunnel or extension over the rear of the snowmobile.

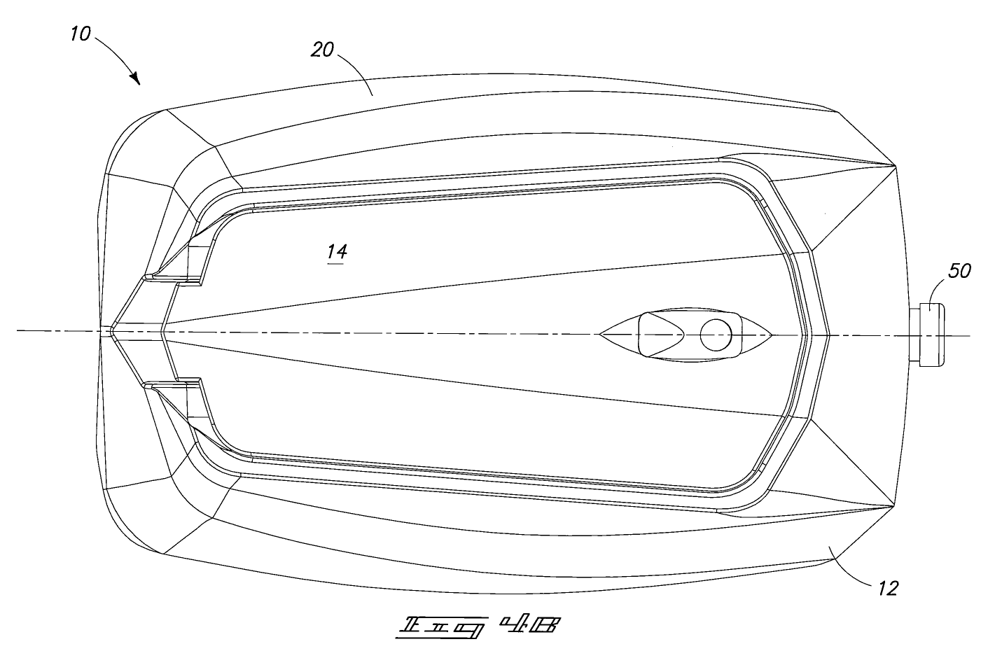

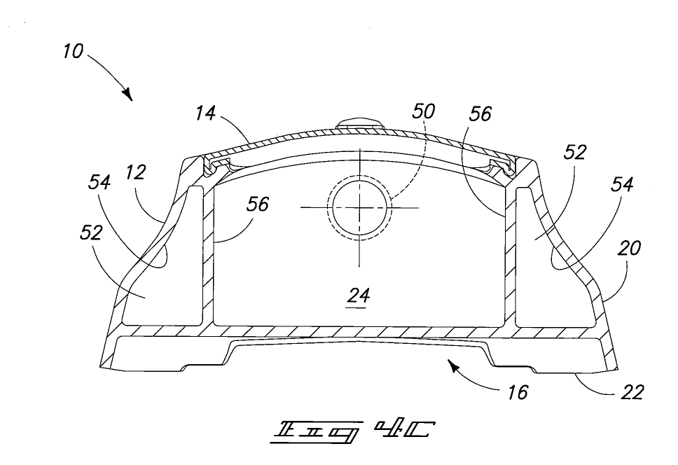

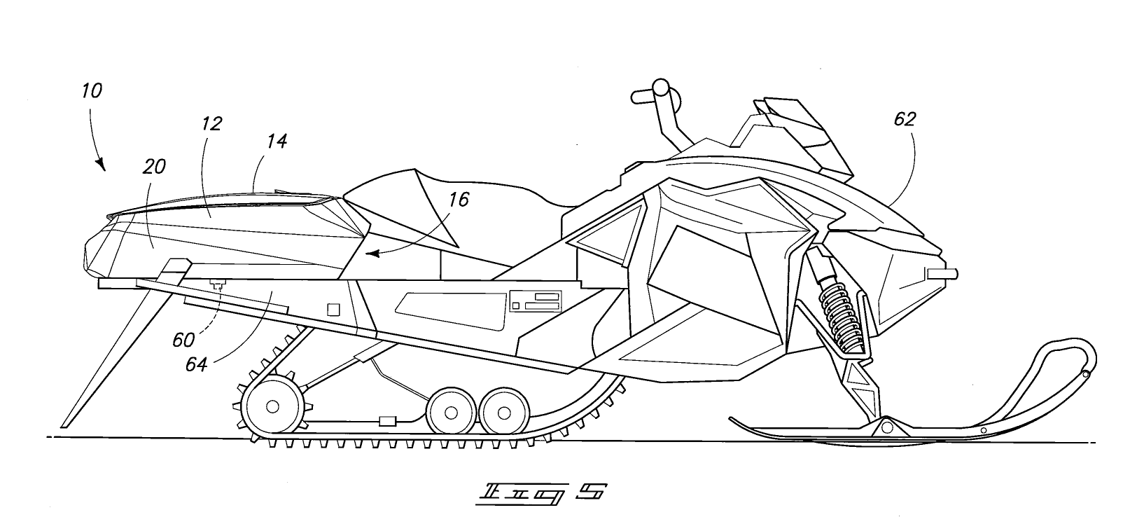

Referring to FIGS. 4A through 4C, according to other example implementations, compartment 10 can be configured to include a void for storing liquids for use during snowmobiling activities. Such liquids can include water, for example, and/or fuel if required. Sidewalls 20 of compartment 10 can define a void 52 between outer sidewalls 54 and inner sidewalls 56. This void can be continuous throughout the perimeter of the compartment and extend to a cap assembly 50. Such cap assembly can be a screw cap and/or snap cap design depending on the application. According to example implementations, this can be considered a double walled storage compartment. According to example implementations, the cap assembly 50 can also be configured as a spout in fluid communication with void 52. In accordance with this implementation, liquid may be maintained in the perimeter of the compartment while dry goods and/or tools are in the interior of the compartment.

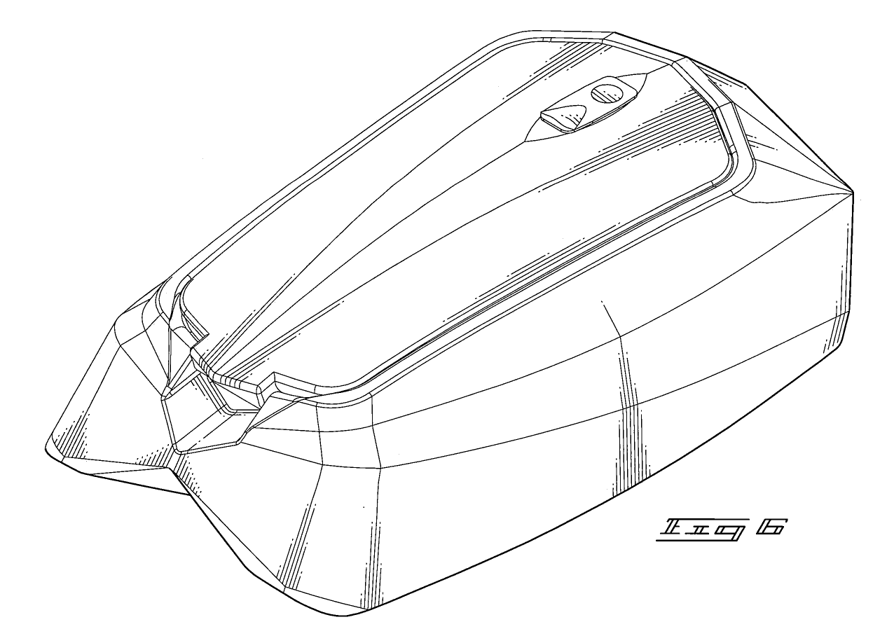

Referring to FIG. 5, according to example implementations, snowmobile 62 can have compartment 10 mounted thereto. According to particular embodiments, a method for mounting a storage compartment to a snowmobile can include mounting a portion of a hasp 60 to a portion of a snowmobile 62. According to an example implementation, the portion that hasp 60 is mounted to is referred to as the tunnel portion 64, or the portion extending over the rear portion of the snowmobile tracks or treads. The method can further include providing a storage compartment 10 having another portion of hasp 60 mounted thereto and the method can further provide coupling the portions of hasp 60 to mount compartment 10 to snowmobile 62. According to example implementations, the coupled compartment 10 can have hasp 60 received below the compartment and within a perimeter defined by the compartment.

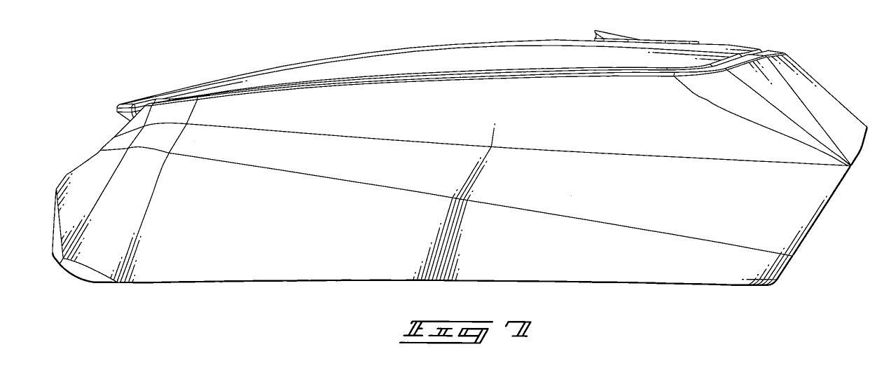

FIGS. 7-12 depict an ornamental design of a snowmobile accessory.

In compliance with the statute, embodiments of the invention have been described in language more or less specific as to structural and methodical features. It is to be understood, however, that the entire invention is not limited to the specific features and/or embodiments shown and/or described, since the disclosed embodiments comprise forms of putting the invention into effect. The invention is, therefore, claimed in any of its forms or modifications within the proper scope of the appended claims appropriately interpreted in accordance with the doctrine of equivalents.

What is claimed is:

1. A removable storage compartment configured to mount rear of a snowmobile seat, the compartment comprising:
a compartment housing formed to extend along sidewalls from a base portion and define an opening, the sidewalls defining the outermost portion of the compartment in one cross section; and
a lid configured to couple with the housing and at least partially close the opening, wherein the lid does not extend beyond the outermost portion of the sidewalls when coupled with the housing in one cross section.

2. The storage compartment of claim 1 wherein the compartment housing comprises a rigid material.

3. The storage compartment of claim 2 wherein the compartment comprises polycarbonate.

4. The storage compartment of claim 1 wherein the lid comprises a rigid material.

5. The storage compartment of claim 4 wherein the lid is hinged to the compartment.

6. The storage compartment of claim 5 wherein the lid and compartment both include complimentary components of a latching assembly.

7. The storage compartment of claim 1 wherein the compartment is configured to be bolted to the snowmobile.

8. The storage compartment of claim 1 wherein both the lid and compartment include complimentary portions configured to provide a rigid coupling when the lid is coupled to the compartment.

9. The storage compartment of claim 1 wherein the outer edge of the lid is configured to compliment the inner edge of the sidewalls to form an arcuate joint.

10. A removable storage compartment configured to mount rear of a snowmobile seat, the compartment comprising:
a compartment housing formed to extend vertically along sidewalls from a base portion and define an opening above the base portion, the sidewalls defining the outermost portion of the compartment in one cross section;
a lid configured to compliment the opening; and
a least one mounting bracket recessed within at least one of the sidewalls.

11. The compartment of claim 10 wherein the compartment is configured to be removably-affixedly coupled to the snowmobile.

12. The storage compartment of claim 10 wherein the mounting bracket is a hasp.

13. The storage compartment of claim 12 wherein the hasp is a draw hasp.

14. The storage compartment of claim 10 wherein the housing and lid define an interior of the compartment.

15. The storage compartment of claim 14 wherein the interior of the compartment is undivided.

16. The storage compartment of claim 14 wherein the interior of the compartment further defines regions configured to receive additional accessories and/or tools.

17. The storage compartment of claim 10 wherein the sidewalls of the compartment define a void between outer sidewalls defining the perimeter of the compartment and inner sidewalls defining an interior of the compartment.

18. The storage compartment of claim 17 wherein the void is configured to contain a fluid and at least a portion of one of the sidewalls defines a cap assembly.

19. A method of mounting a storage compartment to a snowmobile comprising:
mounting a portion of a hasp to a portion of a snowmobile;
providing a storage compartment having another portion of the hasp mounted thereto; and
coupling the portions of the hasp to mount the compartment to the snowmobile, the coupled compartment having the hasp recessed below the compartment and within a perimeter define by the compartment.

20. The method of claim 19 wherein the hasp is a draw hasp.

21. The method of claim 19 wherein the storage compartment is mounted to the rear portion of the snowmobile rear of the seat of the snowmobile.

22. The ornamental design for a snowmobile accessory as shown.
